(19) United States
(12) Patent Application Publication
(10) Pub. No.: US 2024/0141930 A1
(43) Pub. Date: May 2, 2024

(54) LOG SPLITTING MACHINE

(71) Applicant: The Toro Company, Bloomington, MN (US)

(72) Inventor: Benjamin Allan STREET, Northfield, MN (US)

(21) Appl. No.: 18/495,969

(22) Filed: Oct. 27, 2023

Related U.S. Application Data
(60) Provisional application No. 63/381,344, filed on Oct. 28, 2022.

(51) Int. Cl. F15B 15/14; F15B 15/20

(52) U.S. Cl. CPC F15B 15/1457; F15B 15/1409; F15B 15/1428; F15B 15/202; F15B 2211/20515; F15B 2211/7052

(57) ABSTRACT

A battery-powered log splitting machine can include a frame structure, a first hydraulic actuator supported by the frame structure and including a first piston rod assembly movable between extended and retracted positions, a splitter wedge connected to the piston rod assembly, a second hydraulic actuator in fluid communication with the first hydraulic actuator in a series arrangement, a linear electric actuator operably coupled to the first hydraulic actuator, a battery pack for powering the linear electric actuator, and an operator input controlling operation of the linear electric actuator. When the operator input is displaced in a first direction, the electric motor is energized to result in the first piston rod assembly moving towards the extended position. When the operator input is displaced in a second direction, the electric motor is energized to result in the first piston rod assembly moving towards the retracted position.

### CROSS-REFERENCE TO RELATED APPLICATIONS

This application claims priority to U.S. Provisional Patent Application No. 63/381,344, filed Oct. 28, 2022, and is incorporated herein by reference.

### BACKGROUND

Log splitting machines are known. Typical log splitting machines utilize a hydraulic cylinder to drive a splitter wedge into the end of a log such that the log is split into multiple pieces. In such machines, pressurized fluid is usually generated by a two-stage hydraulic pump wherein flow to the hydraulic cylinder is controlled via an operator input connected to a hydraulic valve. An internal combustion engine is frequently used to drive the hydraulic pump although electric motors is also sometimes used. Improvements are desired.

### SUMMARY

A log splitting machine can include a frame structure, a first hydraulic actuator supported by the frame structure and including a first piston rod assembly movable between extended and retracted positions, a splitter wedge connected to the piston rod assembly, a second hydraulic actuator including a second piston rod assembly and being in fluid communication with the first hydraulic actuator, a linear electric actuator including a rod assembly coupled to the second piston rod assembly and including an electric motor operable to move the piston rod assembly between extended and retracted positions, and an operator input controlling operation of the electric motor. When the operator input is displaced in a first direction, the electric motor is energized to result in the first piston rod assembly moving towards the extended position. When the operator input is displaced in a second direction, the electric motor is energized to result in the first piston rod assembly moving towards the retracted position.

In some examples, the log splitting machine includes a battery pack powering the electric motor.

In some examples, the log splitting machine includes an electronic controller configured to receive an input from the operator input and to send an output to the electric motor.

In some examples, the electronic controller receives an input from the battery pack.

In some examples, the log splitting machine includes a valve assembly located between the first hydraulic actuator and the second hydraulic actuator.

In some examples, the valve assembly includes a relief valve.

In some examples, the log splitting machine includes a third hydraulic actuator including a third piston rod assembly and being in fluid communication with the first hydraulic actuator, the third piston rod assembly being coupled to the rod assembly of the linear electric actuator.

In some examples, the second hydraulic cylinder and the third hydraulic cylinder are differently sized.

In some examples, the log splitting machine includes a valve assembly located between the first hydraulic actuator and the second and third hydraulic actuators.

In some examples, the valve assembly includes a first relief valve associated with the second hydraulic actuator and a second relief valve associated with the third hydraulic actuator.

A battery-powered log splitting machine can include a frame structure, a first hydraulic actuator supported by the frame structure and including a first piston rod assembly movable between extended and retracted positions, a splitter wedge connected to the piston rod assembly, a second hydraulic actuator in fluid communication with the first hydraulic actuator in a series arrangement, a linear electric actuator operably coupled to the first hydraulic actuator, a battery pack for powering the linear electric actuator, and an operator input controlling operation of the linear electric actuator. When the operator input is displaced in a first direction, the electric actuator is energized to result in the first piston rod assembly moving towards the extended position. When the operator input is displaced in a second direction, the electric actuator is energized to result in the first piston rod assembly moving towards the retracted position.

In some examples, the battery-powered log splitting machine includes an electronic controller configured to receive an input from the operator input and to send an output to the linear electric actuator.

In some examples, the electronic controller receives an input from the battery pack.

In some examples, the battery-powered log splitting machine includes a valve assembly located between the first hydraulic actuator and the second hydraulic actuator.

In some examples, the valve assembly includes a relief valve.

In some examples, the battery-powered log splitting machine includes a third hydraulic actuator being in fluid communication with the first hydraulic actuator and being in a parallel arrangement with the second hydraulic actuator, the third hydraulic actuator being operably coupled to the linear electric actuator.

In some examples, the second hydraulic actuator and the third hydraulic actuator are differently sized.

In some examples, the battery-powered log splitting machine includes a valve assembly located between the first hydraulic actuator and the second and third hydraulic actuators.

In some examples, the valve assembly includes a first relief valve associated with the second hydraulic actuator and a second relief valve associated with the third hydraulic actuator.

In some examples, the operator input is a lever.

A log splitting machine can include a frame structure a first hydraulic actuator supported by the frame structure and including a first piston rod assembly, a splitter wedge connected to the first piston rod assembly, a linear electric actuator, a second hydraulic actuator coupled to the linear actuator, a third hydraulic actuator coupled to the linear actuator, and a valve assembly in fluid communication with the first, second, and third hydraulic actuators. The valve assembly can be arranged to, when the linear actuator is energized, deliver fluid from each of the second and third hydraulic actuators to the first hydraulic actuator up to a predetermined threshold pressure and to deliver fluid from only one of the second and third hydraulic actuators to the first hydraulic actuator beyond the predetermined threshold pressure.

In some examples, the predetermined threshold pressure is between 500 psi and 1,000 psi.

In some examples, the second hydraulic actuator has a different capacity in comparison to the third hydraulic actuator.

In some examples, a battery pack powering the electric motor is included.

In some examples, an electronic controller is included and configured to receive an input from the operator input and to send an output to the linear electric actuator.

In some examples, the electronic controller receives an input from the battery pack.

In some examples, the valve assembly includes a relief valve.

In some examples, the valve assembly includes a first relief valve associated with the second hydraulic actuator and a second relief valve associated with the third hydraulic actuator.

A method of actuating a main hydraulic actuator of a log splitting machine is disclosed. The method can include the steps of energizing a linear electric actuator coupled to a second hydraulic actuator and a third hydraulic actuator to cause the second and third hydraulic actuators to generate a fluid pressure, delivering fluid from each of the second and third hydraulic actuators to the main hydraulic actuator up to a predetermined threshold pressure, and delivering fluid from only one of the second and third hydraulic actuators to the main hydraulic actuator beyond the predetermined threshold pressure. In some examples, the predetermined threshold pressure is between 500 psi and 1,000 psi. In some examples, the second hydraulic actuator has a different capacity in comparison to the third hydraulic actuator.

### BRIEF DESCRIPTION OF THE DRAWINGS

FIG. 1 is a perspective view of a log splitting machine including a power and control arrangement in accordance with the principles of the present disclosure.

FIG. 2 is a schematic view of the power and control arrangement of the log splitting machine shown in FIG. 1.

FIG. 3 is a schematic view of the power and control arrangement shown in FIG. 2, operating in an extending or splitting direction.

FIG. 4 is a schematic view of the power and control arrangement shown in FIG. 2, operating in a retracting or return direction.

FIG. 5 is a schematic view of an alternative valve arrangement usable with the log splitting machine shown in FIG. 1.

FIG. 6 is a schematic view of an alternative electro-hydraulic system usable with the log splitting machine shown in FIG. 1.

FIG. 7 is a schematic view a control system usable with the log splitting machine of FIG. 1.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

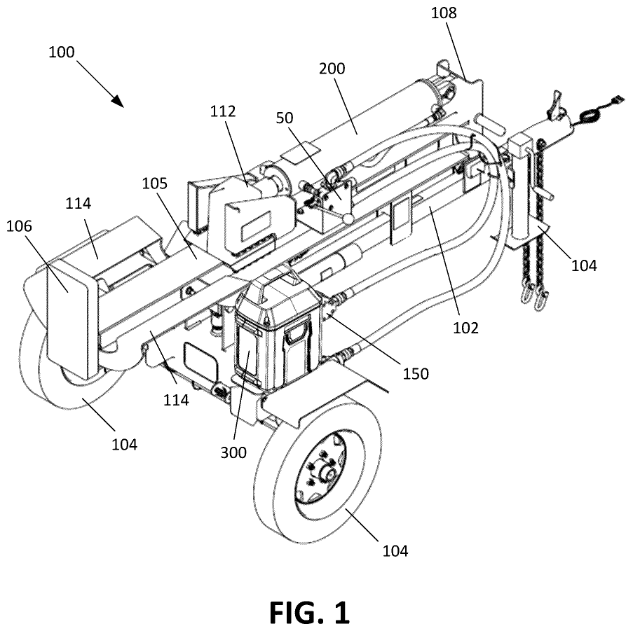

With reference to FIG. 1, an example log splitting machine 100 is disclosed. In one aspect, the log-splitting machine 100 includes a frame or chassis structure 102 supported by a plurality of support members 104. In the example shown, two of the support members 104 are configured as wheels 104 and the frame structure 102 is provided with a hitch for towing such that the log splitting machine 100 can be transported to a work site. In other examples, the frame structure 102 can be in a stationary configuration, wherein the support members 104 are configured, for example, as base feet members 104, as is shown for the front support member 104 proximate the hitch. In one aspect, the frame structure 102 includes a longitudinally extending main beam 105 to which a first end plate 106 and a second end plate 108 are secured.

In one aspect, the log splitting machine 100 includes a first hydraulic actuator 200. As shown, the first hydraulic actuator 200 includes a cylinder 200a secured to the second end plate 108 and includes a piston rod assembly 200b secured to a splitter wedge 112. The log splitting machine 100 can also include a pair of log catcher supports 114 mounted on opposite sides of the main beam 105 and proximate the first end plate 106. The log catcher supports 114 receive and retain the split apart portions of the log that fall to one side or the other of the beam 105 during and after a log-splitting operation. In the example shown, the frame 102 is configured such that the beam 105 can be selectively placed in a horizontal or vertical position.

To conduct a log-splitting operation, the first hydraulic actuator 200 is operable to extend the piston rod assembly 202b such that the splitter wedge 112 is moved in a first direction D1 towards the first end plate 106. When a log is placed onto the main beam 105 between the splitter wedge 112 and the first end plate 106, this motion causes the splitter wedge 112 to move towards the log such that the log is pressed against the first end plate 106 by the splitter wedge 112. From this point, further movement of the splitter wedge 112 in the direction D1 results in the log splitting. After a log-splitting operation has been completed, the actuator 200 can be operated in a return operation in which the piston rod assembly 202b is retracted to move the splitter wedge 112 in a second direction D2 away from the first end plate 106 such that sufficient space is provided between the splitter wedge 112 and the first end plate 106 for receiving another log to be split. As is discussed in more detail in the following paragraphs, the operation of the first hydraulic actuator 200 can be effectuated through the use of an electro-hydraulic system 150 powered via a battery pack 300 and controlled via an operator control station 50. In one aspect, the battery pack 300 is and can be, for example, a 60 volt rechargeable lithium-ion battery pack 300. In some examples, the battery pack 300 is designed to be interchangeable, enabling ease in replacement and remote charging, thereby enabling users to utilize a variety of compatible battery packs with varying capacity (e.g., amp-hour) ratings.

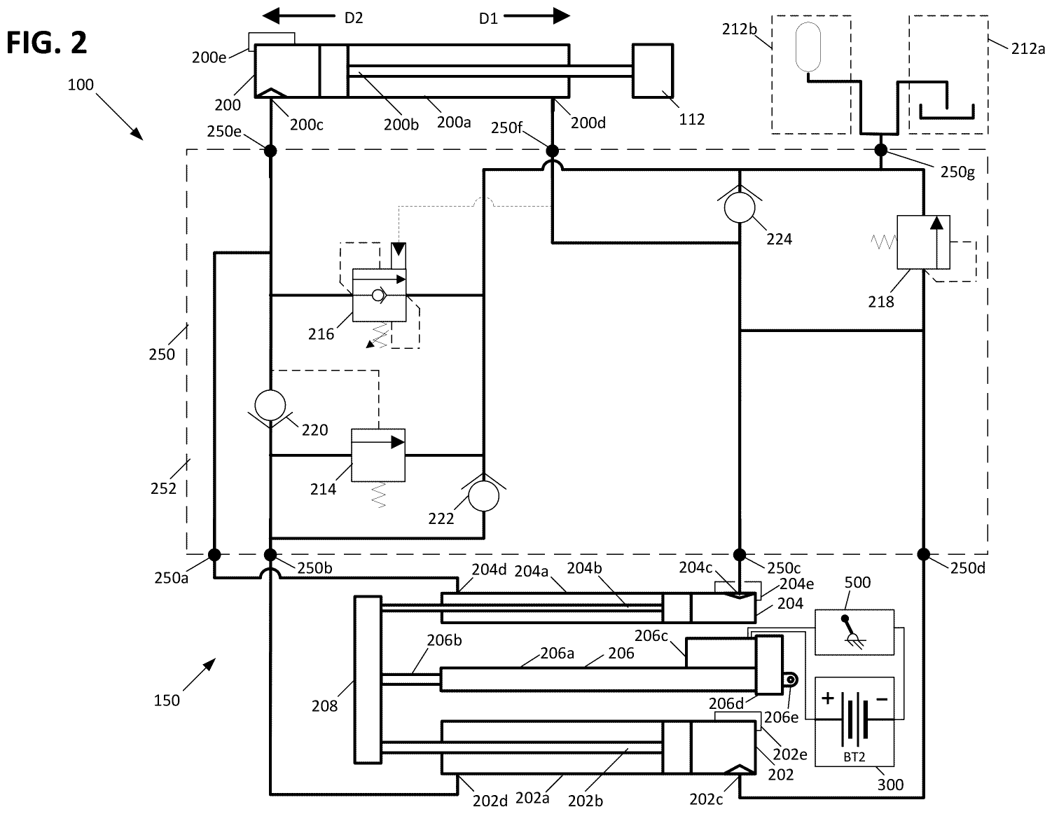

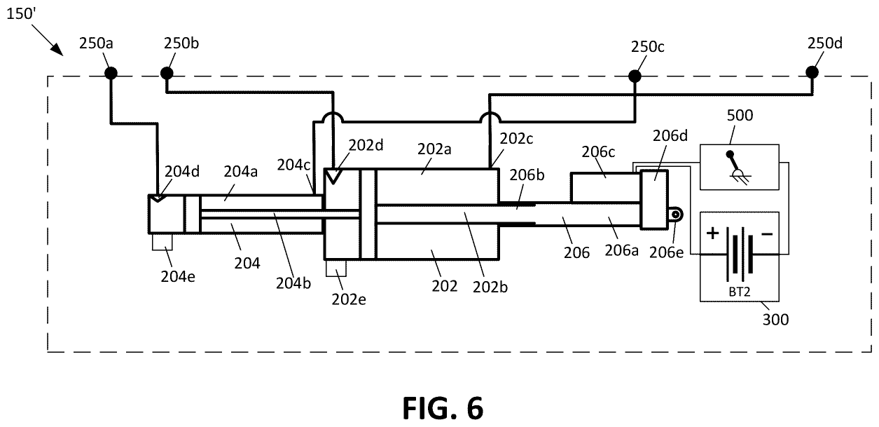

With reference to FIG. 2, a schematic is provided showing the electro-hydraulic system 150 in further detail. As shown, the electro-hydraulic system 150 includes a second hydraulic actuator 202, a third hydraulic actuator 204, a linear electric actuator 206, a valve assembly 250, a battery pack 300, and an operator control station 500. In one aspect, the first hydraulic actuator 200 includes a cylinder 200a, a piston rod assembly 200b, a first port 200c, and a second port 200d. In one aspect, the second hydraulic actuator 202 includes a cylinder 202a, a piston rod assembly 202b, a first port 202c, and a second port 202d. In one aspect, the third hydraulic actuator 204 includes a cylinder 204a, a piston rod assembly 204b, a first port 204c, and a second port 204d. The ports 200c, 202d, 204d may be referred to as head-side ports while the ports 200d, 202c, 204c may be referred to as rod-side ports. In one aspect, the first, second, and third hydraulic actuators 200, 202, 204 are respectively provided with phasing features 200e, 202e, 204e that allow fluid to bypass around the piston of the piston rod assemblies 200b, 202b, 204b between the head side to the rod side when in the fully extended positions such that the first hydraulic actuator 200 can be kept in phase with the second and third hydraulic actuators 202, 204 which are in series with the first hydraulic actuator 200. The phasing features 200e, 202e, 204e may be internal or external to the cylinders 200a, 202a, 204a and may be, for example, provided as orifice structures. Although the phasing features 200e, 202e, 204e are shown as being located at the extension or head end of the cylinders 200a, 202a, 204a, the phasing features 200e, 202e, 204e may be located at the retraction or rod end of the cylinders 200a, 202a, 204a (such as that depicted in FIG. 6).

In the example shown, the second hydraulic actuator 202 is provided with a larger head and cylinder size relative to the third hydraulic actuator 204. As such, during extension, the second hydraulic actuator 202 is configured to develop a relatively higher flow rate at a relatively lower pressure at the second port 202d, in comparison to the flow rate and pressure developed at the port second 204d of the third hydraulic actuator 204. In one characterization, the second hydraulic actuator 202 can be referred to as a high-flow and/or a low-pressure actuator while the third hydraulic actuator 204 can be referred to as a low-flow and/or a high-pressure actuator. With such an arrangement, flow developed by the second hydraulic actuator 202 can be used to quickly engage the splitter wedge 112 against a log and to quickly return the splitter wedge 112 to a start position after a log-splitting operation. This arrangement also allows for the flow developed by the third hydraulic actuator 204, which is at a higher pressure, to be used during the actual log-splitting operation where higher forces are required.

The linear electric actuator 206 is shown as including a housing 206a, a rod assembly 206b, an electric motor 206c, a drive mechanism 206d transmitting power from the electric motor 206c to move the rod assembly 206b, and a rear mount 206e. In one aspect, the cylinders 202a, 204a and housing 206a are supported by a portion of the log splitting machine 100 such as the frame 102, main beam 105, and first and second end plates 106, 108.

In one aspect, the piston rod assemblies 202b, 204b and the rod assembly 206b of the linear electric actuator 206 are connected together at their ends by a connecting structure 208, which may be formed as a bracket structure. With such a configuration, when the motor 206c of the linear electric actuator 206 is energized to rotate in a first or second direction to move the rod assembly 206b to respectively extend or retract (e.g., in the first or second directions D1, D2), the piston rod assemblies 202b, 204b are forced to similarly extend or retract. As such, when the piston rod assemblies 202b, 204b are forced by the electric actuator 206 to extend, pressurized fluid is generated at the respective second ports 202d, 204d while fluid is drawn into respective first ports 202c, 204c. Likewise, when the piston rod assemblies 202b, 204b are forced by the electric actuator 206 to retract, pressurized fluid is generated at the respective first ports 202c, 204c while fluid is drawn into the respective second ports 202d, 204d.

With continued reference to FIG. 2, the valve assembly 250 is shown as including ports 250a-250g, wherein a first port 250a is in fluid communication with the second port 204d of the third hydraulic cylinder 204, a second port 250b is in fluid communication with the second port 202d of the second hydraulic cylinder 202d, a third port 250c is in fluid communication with the first port 204c of the third hydraulic actuator 204, a fourth port 250d is in fluid communication with the first port 202c of the second hydraulic actuator 202, a fifth port 250e is in fluid communication with the port first 200c of the first hydraulic actuator 200, a sixth port 250f is in fluid communication with the second port 200d of the second hydraulic actuator 200, and a seventh port 250g is in fluid communication with a fluid reservoir or tank 212a of the electro-hydraulic system 150. As illustrated schematically, the seventh port 250g may be alternatively or additionally connected to an accumulator 212b to facilitate charging of the hydraulic system. The valve assembly 250 is further shown as including valves 214, 216, 218, 220, 222, 224, which collectively control flow between the first hydraulic actuator 200 and the second and third hydraulic actuators 202, 204. In the example shown, the valves 214, 216, 218 are configured as relief valves and while the valves 220, 222, 224 are configured as check valves, such as spring check valves having a nominal spring pressure, such as 5 psi (pounds per square inch). In one example, the valves 214, 216, 218, 220, 222, 224 are provided within a single valve block 252 with porting interconnecting the valves 214, 216, 218, 220, 222, 224 with the ports 250a-250g. In some examples, the valves 214, 216, 218, 220, 222, 224 are provided within multiple separate valve block structures or are provided without the use of any valve block structures at all.

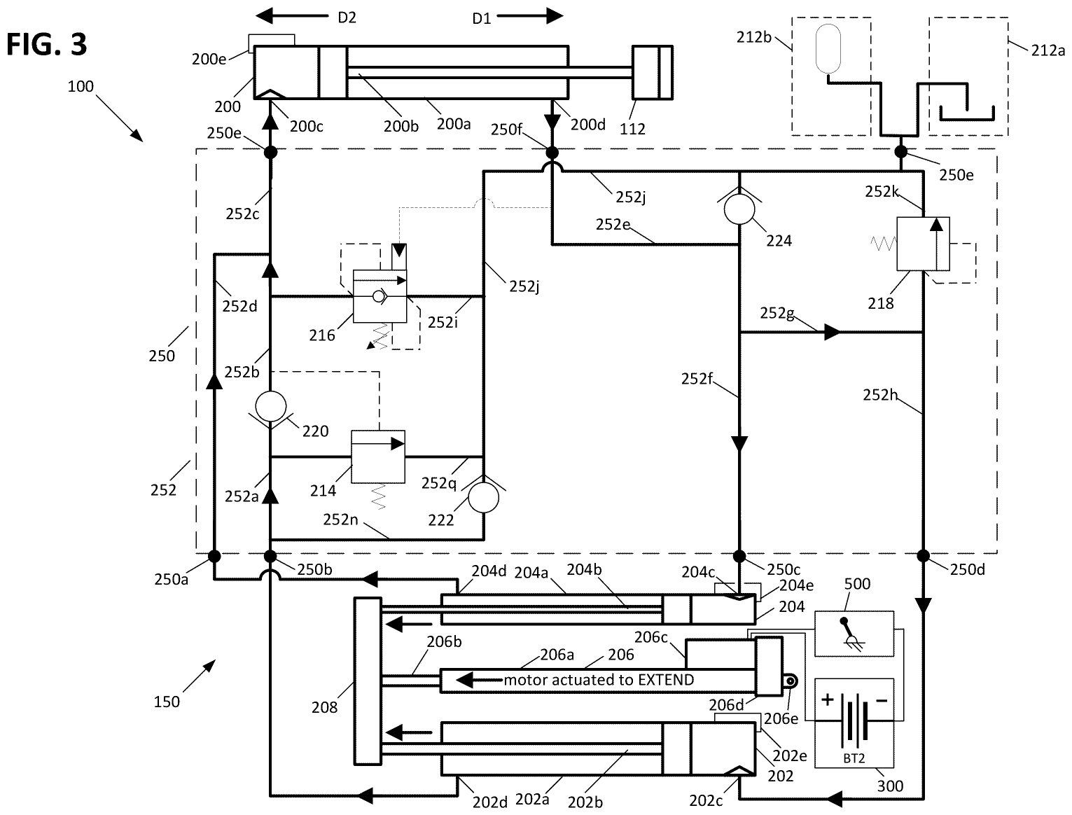

Referring to FIG. 3, the electro-hydraulic system 150 is shown as being operated in a log-splitting operation such that first hydraulic actuator 200 is extended to move the splitter wedge 112 in the direction D1. To accomplish this operation, the electric motor 206c of the linear electric actuator is activated to cause the rod assembly 206b to extend which in turn drives the piston rod assemblies 202b, 204b to extend. As stated previously, this motion generates a positive fluid pressure at the ports 202d, 204d. In one aspect, pressurized fluid from the port 202d is delivered from the port 250b to the port 250e, via check valve 220 and passageways 252a, 252b, 252c, and then to the head-side port 200c to effectuate movement of the piston rod assembly 200b and splitter wedge 112 in the direction D1. Simultaneously, pressurized fluid from the port 204d is delivered from the port 250a to the port 250e, via passageways 252d and 252c, and then to the head-side port 200c. Fluid is returned to the second and third hydraulic actuators 202, 204 from port 200d to ports 202c, 204c, via ports 250f, 250c, 250d and passageways 252e-252h.

During the extension or log-splitting operation, the relief valves 214 and 216 operate to provide a safety pressure relief function in which the relief valve 214 may be characterized as a low-pressure relief valve 214 and in which the relief valve 216 may be characterized as a high-pressure relief valve 216. As configured, the relief valve 214 is arranged to direct pressurized fluid received from the port 250b to the tank 212 via passageways 252q, 252j when fluid pressure exceeds a first pressure condition defined by the relief valve 214. In one aspect, the first pressure condition corresponds to a maximum pressure that prevents potential damage to the second hydraulic actuator 202. The relief valve 216 is arranged to direct pressurized fluid from the port 250a to the tank via passageways 252i, 252j when fluid pressure exceeds a second pressure condition defined by the relief valve 216. The check valve 220 is arranged in a passageway 252b such that pressurized fluid received from the port 250a is unable to act on the relief valve 214.

In one aspect, the second pressure condition, which is higher than the first pressure condition, corresponds to a maximum pressure that prevents potential damage to the first and second hydraulic actuators 200, 202. In one example, the first pressure condition is between 100 psi and 2,000 psi while the second pressure condition is between 100 psi and 3,000 psi. In one example, the first pressure condition is 750 psi while the second pressure condition is 3,000 psi. In conditions where fluid is passing through either of the relief valves 214, 216, the check valve 224 allows for fluid to be returned to the ports 250c, 250d via passageways 252f, 252g, and 252h. Where additional fluid is required, fluid can also be drawn from the tank 212 via check valve 224.

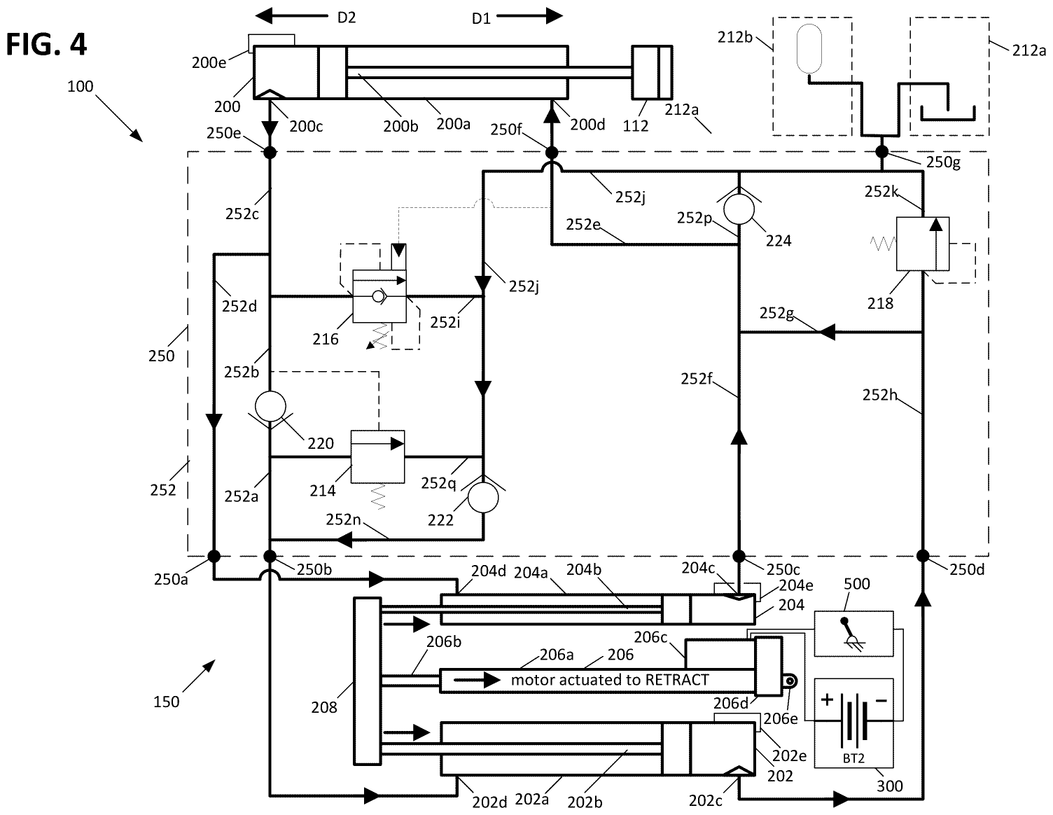

Referring to FIG. 4, the electro-hydraulic system 150 is shown as being operated in a return operation such that first hydraulic actuator 200 is retracted to move the splitter wedge 112 in the direction D2. To accomplish this operation, the electric motor 206c of the linear electric actuator is activated to cause the rod assembly 206b to retract which in turn drives the piston rod assemblies 202b, 204b to retract. This motion generates a positive fluid pressure at the ports 202c, 204c. In one aspect, pressurized fluid from the port 202c is delivered from port 250d to port 250f, via passageways 252h, 252g, 252e, and then to the rod-side port 200d to effectuate movement of the piston rod assembly 200b and splitter wedge 112 in the direction D2. Simultaneously, pressurized fluid from the port 204c is delivered from the port 250c to the port 250f, via passageways 252f and 252e, and then to the rod-side port 200d. In one aspect, fluid is returned to the second hydraulic actuator 202 from port 200c via ports 250e and 250b and passageways 252c, 252i, 252j, 252n, and check valve 222.

To facilitate flow back to port 250b, the valve 216 is additionally piloted by pressure from the port 250f to open during the return operation to selectively allow for flow from passageway 252c to passageway 252i via passageway 252i when pressure at the port 250f exceeds a predetermined pressure threshold. In one example, this pressure threshold is 300 psi or lower. In one example, the valve 216 is configured as a counterbalance valve with a 10:1 ratio or higher between the high-pressure relief function and the relatively lower pressure drain function. The check valve 222 allows for flow from passageway 252j to passageway 252n during the return operation while preventing flow in the reverse direction during the log-splitting operation. In one aspect, fluid is returned to the hydraulic cylinder 204 from port 200c via ports 250e and 250a and passageways 252c, 252d. The relief valve 218 provides a passageway between the ports 250f, 250c, 250d and the tank 212, via passageways 252e, 252f, 252g, 252h, 252k in the event that unexpectedly high pressure develops during the return operation. In one example, the relief valve has a pressure setting of 120 psi.

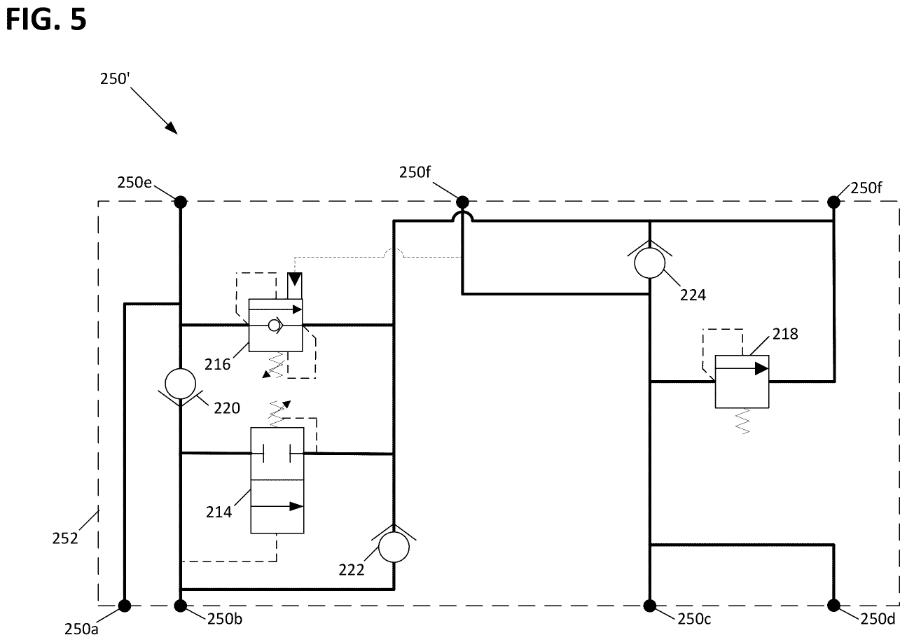

Referring to FIG. 5, a second example of a valve assembly 250′ is shown as that is usable with the log splitting machine 100, as previously described. The valve assembly 250′ shares many features in common with the valve assembly 250, but does show a different general passageway routing configuration. Valve assembly 250′ also differs from valve assembly 250 in that the location of the relief valve 218 is slightly modified. Valve assembly 250′ is further different from valve assembly 250 in that valve 214 is configured as a two-position, two-way valve that is spring biased and piloted with downstream pressure toward a closed position and that is piloted by pressure from port 250b towards the open position to provide a relief function.

Referring to FIG. 6, an alternate embodiment of the electro-hydraulic system 150′, is depicted for use with log splitting machine 100. As depicted, the electro-hydraulic system 150′ includes a second hydraulic actuator 202, a third hydraulic actuator 204, a linear electric actuator 206, a battery pack 300, and an operator control station 500. Electro-hydraulic system 150′ shares many features in common with the electro-hydraulic system 150, with a potentially more compact arrangement of the second and third hydraulic actuators 202, 204 (e.g., omitting the need for a connecting structure 208, etc.).

Contrary to the parallel configuration seen in electro-hydraulic system 150 (illustrated in FIGS. 2-4), in this alternate embodiment, the second and third hydraulic actuators 202, 204 are serially linked with the linear electric actuator 206. The drive mechanism 206d of the linear electric actuator 206 is axially aligned with, and operably coupled to, the piston rod assemblies 202b, 204b of the second and third hydraulic actuators 202, 204, thereby omitting the need for a connecting structure 208, ensuring a higher flow rate at a decreased pressure by the second hydraulic actuator 202 for swift engagement and retraction of the splitter wedge 112. Simultaneously, the third hydraulic actuator 204 provides a lower flow rate at an increased pressure during log-splitting operations necessitating higher force application.

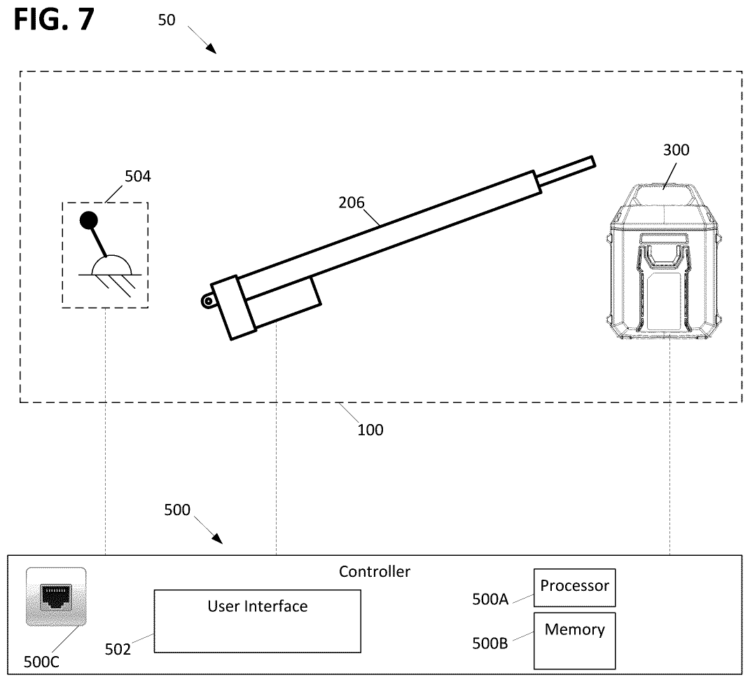

Referring to FIG. 7, the control components of the above-described log splitting machine 100 are shown in further detail. In one aspect, an operator control station 50 including an electronic controller 500 is provided for effectuating operation of the log splitting machine 100. In one aspect, the controller 500 includes a processor 500A and a non-transient storage medium or memory 500B, such as RAM, a flash drive, or a hard drive. Memory 500B is for storing executable code, the operating parameters, and the input from an operator user interface 502, while processor 500A is for executing the code. Memory 500B can also be for storing reference information, such as maps and/or lookup tables. The electronic controller is also shown as including a transmitting/receiving port 500C, such as an Ethernet port for two-way communication with a WAN/LAN related to an automation system. The user interface 502 may be provided, for example at a control panel to activate and deactivate the system, allow a user to manipulate certain settings or inputs to the controller 500, and to view information about the system operation. The electronic controller 500 typically includes at least some form of memory 500B. Examples of memory 500B include computer readable media.

Computer readable media includes any available media that can be accessed by the processor 500A. By way of example, computer readable media can include computer readable storage media and computer readable communication media. Computer readable storage media includes volatile and nonvolatile, removable and non-removable media implemented in any device configured to store information such as computer readable instructions, data structures, program modules, or other data.

Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the processor 500A. Computer readable communication media typically embodies computer readable instructions, data structures, program modules, or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

With continued reference to FIG. 7, the electronic controller 500 is also shown as having a number of inputs/outputs that may be used for operating the log splitting machine. In some examples, the controller 500 can be configured to receive input signals from an operator input 504, input signals from the battery pack 300, and an output signal to the linear electric actuator motor 206c, wherein the controller allows power from the battery pack 300 to selectively energize the electric motor 206c based on an input signal received from the operator input 504. In the example shown, the operator input 504 is configured as a lever assembly movable between forward and reverse positions that is configured to return to a neutral position when the lever is released. Other types of operator inputs 504 may be used. In an example log-splitting operation, when an operator displaces the operator input 504 in a first or forward direction, the controller 500 energizes the electric motor 206c, via power from the battery pack 300, to extend in the first direction D1 until the rod assembly 206b is fully extended, the operator input 504 is released or moved into a neutral position, and/or the operator input 504 is displaced in a second or reverse direction. In an example return operation, when an operator displaces the operator input 504 in the second or reverse direction, the controller 500 energizes the electric motor 206c, via power from the battery pack 300, to retract in the second direction D2 until the rod assembly 206b is fully retracted, the operator input 504 is released or moved into a neutral position, and/or the operator input 504 is displaced in the first or forward direction. In some examples, the controller 500 can be configured to fully retract the rod assembly 206b when the operator displaces the operator input 504 in a specific manner, such as by extending the operator input 504 until a detent is engaged.

The controller 500 can be additionally configured to receive an input from a hydraulic pressure sensor in fluid communication with the cylinder 200a to terminate a log-splitting operation to either stop the electric motor 206c or reverse operation of the electric motor 206c to retract when the pressure in the cylinder 200a exceeds a predetermined safety setpoint. In some examples, the controller 500 can be configured to automatically de-energize the actuator 206 when the actuator reaches the fully extended and retracted positions. Alternatively, the actuator 206 can be configured to cut power to the motor 206c in either position with internal circuitry. For example, in some examples, the controller 500 is configured to automatically deenergize the actuator 206 when there is no demand, thereby preserving battery life and enhancing the overall efficiency of the system. In some examples, a separate controller 500 is not provided such that the operator input 504 interfaces directly with the battery pack 300 to directly control power and polarity to the electric linear actuator 206.

Although the depicted embodiments are directed to log splitters, the disclosed electro-hydraulic system 150 can be used in a variety of other applications. For example, the electro-hydraulic system 150, with its capability to generate high force and torque, move heavy loads at reasonable speeds, and handle shock and impact effectively, can have applications in various fields, such as lawn care, snow handling, construction, agriculture, tree and forestry care, and sports field and golf course maintenance. Instead of the splitter wedge 112, a variety of other tool heads can be attached to the piston rod assembly 200b to adapt the machinery for specific tasks. A noncomprehensive list of tool heads includes a mower deck for adjustable grass cutting, aerator spikes or plugs to improve root growth by perforating the soil, and plow blades or snow blowers for managing snow. Additional tools like a bucket for moving materials like sand or soil, a hammer or breaker for demolishing concrete, an auger for drilling holes, a grapple to grasp or lift objects, or a compactor or driver head for flattening surfaces can also be attached. This adaptability allows the disclosed electro-hydraulic system 150 to provide sturdy and accurate performance, enhancing utility in a variety of industries and applications.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

1. A log splitting machine comprising:
a) a frame structure;
b) a first hydraulic actuator supported by the frame structure and including a first piston rod assembly movable between a first extended position and a first retracted position;
c) a splitter wedge connected to the first piston rod assembly;
d) a second hydraulic actuator including a second piston rod assembly, wherein the second hydraulic actuator is in fluid communication with the first hydraulic actuator;
e) a linear electric actuator including a rod assembly coupled to the second piston rod assembly and including an electric motor operable to move the piston rod assembly between a second extended position and a second retracted position; and
f) an operator input controlling operation of the electric motor, wherein:
i) when the operator input is displaced in a first direction, the electric motor is energized to result in the first piston rod assembly moving towards the first extended position; and
ii) when the operator input is displaced in a second direction, the electric motor is energized to result in the first piston rod assembly moving towards the first retracted position.

2. The log splitting machine of claim 1, further including a battery pack powering the electric motor.

3. The log splitting machine of claim 1, further including an electronic controller configured to receive an input from the operator input and to send an output to the electric motor.

4. The log splitting machine of claim 3, wherein the electronic controller receives an input from the battery pack.

5. The log splitting machine of claim 1, further including a valve assembly located between the first hydraulic actuator and the second hydraulic actuator.

6. The log splitting machine of claim 5, wherein the valve assembly includes a relief valve.

7. The log splitting machine of claim 1, further including:
a) a third hydraulic actuator including a third piston rod assembly, wherein the third hydraulic actuator is in fluid communication with the first hydraulic actuator, the third piston rod assembly being coupled to the rod assembly of the linear electric actuator.

8. The log splitting machine of claim 7, wherein the second hydraulic actuator and the third hydraulic actuator are differently sized.

9. The log splitting machine of claim 7, further including a first relief valve associated with the second hydraulic actuator and a second relief valve associated with the third hydraulic actuator.

10. A method of actuating a main hydraulic actuator of a log splitting machine, the method comprising:
a) energizing a linear electric actuator coupled to a second hydraulic actuator and a third hydraulic actuator to cause the second and third hydraulic actuators to generate a fluid pressure;
b) delivering fluid from each of the second and third hydraulic actuators to the main hydraulic actuator up to a predetermined threshold pressure; and
c) delivering fluid from only one of the second and third hydraulic actuators to the main hydraulic actuator beyond the predetermined threshold pressure.

11. The method of claim 10, wherein the predetermined threshold pressure is between 500 psi and 1,000 psi.

12. The method of claim 10, wherein the second hydraulic actuator has a different capacity in comparison to the third hydraulic actuator.

13. An electro-hydraulic actuator, comprising:
a) a frame structure;
b) a first hydraulic actuator supported by the frame structure and including a first piston rod assembly;
c) a tool head connected to the first piston rod assembly;
d) a linear electric actuator;
e) a second hydraulic actuator coupled to the linear electric actuator;
f) a third hydraulic actuator coupled to the linear electric actuator; and
g) a valve assembly in fluid communication with the first, second, and third hydraulic actuators and arranged to, when the linear electric actuator is energized, deliver fluid from each of the second and third hydraulic actuators to the first hydraulic actuator up to a predetermined threshold pressure and to deliver fluid from only one of the second and third hydraulic actuators to the first hydraulic actuator beyond the predetermined threshold pressure.

14. The electro-hydraulic actuator of claim 13, wherein the predetermined threshold pressure is between 500 psi and 1,000 psi.

15. The electro-hydraulic actuator of claim 13, wherein the second hydraulic actuator has a different capacity in comparison to the third hydraulic actuator.

16. The electro-hydraulic actuator of claim 13, further including a battery pack powering an electric motor of the linear electric actuator.

17. The electro-hydraulic actuator of claim 16, further including an electronic controller configured to receive an input from the operator input and to send an output to the linear electric actuator.

18. The electro-hydraulic actuator of claim 17, wherein the electronic controller receives an input from the battery pack.

19. The electro-hydraulic actuator of claim 13, wherein the valve assembly includes a relief valve.

20. The electro-hydraulic actuator of claim 13, wherein the valve assembly includes a first relief valve associated with the second hydraulic actuator and a second relief valve associated with the third hydraulic actuator.
